(19) United States
(12) Patent Application Publication
(10) Pub. No.: US 2023/0299455 A1
(43) Pub. Date: Sep. 21, 2023

(54) Radio Frequency (RF) and Infrared (IR) Transparent Resistive Heaters

(71) Applicant: Battelle Memorial Institute, Columbus, OH (US)

(72) Inventors: David R. Chase, Columbus, OH (US); Matthew E. Huntwork, Columbus, OH (US); Kurt M. Bosworth, Woodstock, OH (US)

(21) Appl. No.: 18/099,912

(22) Filed: Jan. 20, 2023

Related U.S. Application Data
(60) Provisional application No. 63/301,473, filed on Jan. 20, 2022.

(51) Int. Cl. H01Q 1/02; H01Q 1/42; H05B 3/14

(52) U.S. Cl. CPC H01Q 1/02; H01Q 1/42; H05B 3/145; H05B 2203/013; H05B 2203/016; H05B 2214/02; H05B 2214/04

(57) ABSTRACT

Resistive heating systems are described that have alternating, concentric positive and negative electric leads coated by a thin resistive heating layer. The resistive heating system, especially when the coating is a CNT coating, exhibits excellent transmittance in the L, S, C, X, and/or Ku bands. The resistive heating system is well-suited for a radome, and the invention includes a transmitter system and/or receiver system, especially for radio or infrared transmissions. The invention also provides a polarizable resistive heating system having a comb-like structure of alternated or interdigitated positive and negative leads.

### RELATED APPLICATIONS

This application claims the priority benefit of U.S. Provisional Pat. Application No. 63/301,473 filed Jan. 20, 2022.

### SUMMARY OF THE INVENTION

In a first aspect, the invention provides a resistive heater system, comprising: a substrate; a resistive heating element disposed on the substrate comprising a plurality of alternating, concentric positive and negative electric leads coated by a resistive heating layer.

In another aspect, the invention provides a resistive heater system comprising: a substrate; a resistive heating element disposed on the substrate comprising alternating positive and negative electric leads coated by a CNT resistive heating layer having a thickness in the range of 15 to 200 nm, or 15 to 100 nm and a resistance of 100 to 400 ohm/sq. As is conventional, a “lead” is an electrically conductive material designed to form an electrical circuit that includes a pathway through the CNT resistive heating layer. Also, as conventional, thickness is the direction perpendicular to width and parallel to the normal vector to the upper and lower major surfaces of the CNT resistive heating layer; preferably the CNT resistive heating layer has an average thickness between these values averaged over the surface area covered by the CNT resistive heating layer. Typically, the leads are on the bottom major surface of the resistive layer; typically disposed on a substrate and in contact with the resistive heating layer. Leads can be linear or curved.

In a further aspect, the invention provides a polarizable resistive heater system, comprising: a substrate; a resistive heating element disposed on the substrate comprising a comb-like structure of positive and negative electric leads coated by a resistive heating layer; wherein the comb-like structure comprises a series of at least 3 positive electric leads alternated (or interdigitated) with at least 3 negative electric leads. Polarization is a causal consequence of linear parallel structures; the system is polarizing in use but described by the more general term polarizable since the system need not always be in the presence of radiation.

In any of the aspects, the invention can be further characterized by one or any combination of the following: wherein the resistive heating layer is at least 70% transparent or at least 80% transparent in the wavelength range of one or any combination of 1 to 4 GHz, or 1 to 10 GHz, or 2 to 18 GHz, or from 4 to 16 GHz, or in the L Band, S Band, C Band, X Band, and/or Ku Band; preferably, a resistive heater system maintains this level of transparency while constant current is passed through the system to generate heat sufficient to melt a 3 mm ice layer from the surface of the system in an ambient atmosphere maintained at -20° C.; wherein the positive leads share a common first lead and the negative leads share a common second lead.

The resistive heater system may be a radome. The invention also includes a transmitter or receiver system comprising a radio and/or infrared transmitter or receiver at least partly housed within the resistive heater system. The invention further includes methods of transmitting or receiving radio and/or infrared signals, typically while generating heating from the resistive heater system, preferably generating heat sufficient to melt a 3 mm ice layer from the surface of the system in an ambient atmosphere maintained at -20° C.

The invention (or the resistive heating layer) may also be further characterized by having one or any combination of the properties (or within ±30% or ±20% or ±10% or ±5%) of one or any combination of the properties described herein including in the Examples. For example, any aspect of the invention can be further characterized by the transmittance (or within ±30% or ±20% or ±10% or ±5% of the transmittance) as a function of wavelength data shown here. Throughout this specification, “significant” or “substantial” indicates a change of at least 20%, preferably at least 10%.

The invention is often characterized by the term “comprising” which means “including,” and does not exclude additional components. In narrower aspects, the term “comprising” may be replaced by the more restrictive terms “consisting essentially of” or “consisting of.” This is conventional patent terminology.

### BRIEF DESCRIPTION OF THE DRAWINGS

FIG. 1 lists some radio frequency (RF) and infrared frequency (IR) signal ranges.

FIG. 2 illustrates a standard configuration (left), a concentric configuration with a first common connection to the positive leads and a second common connection to the negative leads, and a comb configuration of electric leads.

FIG. 3 illustrates a concentric configuration with two sets of common electric leads.

FIG. 4 shows transmittance as a function of frequency at resistances of 1469 ohm/square and 947 ohm/square for the standard configuration.

FIG. 5 shows transmittance as a function of frequency at a variety of resistances for the concentric configuration. Lead geometry is not position sensitive and a knee is observed around 3.8 GHz.

FIGS. 6A and 6B show transmittance as a function of frequency for several samples. FIG. 6A shows transmittance for concentric samples. FIG. 6B shows transmittance for comb samples.

FIG. 7 shows a summary of results for various configurations.

FIG. 8 shows transmittance as a function of wavelength for several samples.

### DETAILED DESCRIPTION OF THE INVENTION

In the present invention, the resistive heater includes electric leads and one or more resistive heating layers disposed over a substrate. The substrate is desirably substantially transparent to the wavelengths of interest and preferably transparent to the relevant parts of the spectrum of both RF and IR. In some preferred embodiments, the substrate comprises ZnS, sapphire, or aluminum oxynitride.

Preferably, the substrate forms part of a housing for a RF and/or IR transmitter or receiver - for example an antenna, radar, or thermal imager. The invention includes devices comprising a receiver and/or transmitter in the L Band, S Band, C Band, X Band, Ku Band, or IR in the range of 20-37 THz or 37-100 THz within the housing. In some preferred embodiments, the housing is an enclosure such as a radome.

The inventive heaters comprise resistive heating layers disposed between positive and negative electrical leads such that, during operation, current flows through from one lead to another through the heating layer which provides a resistance that creates heat. The leads can be any conductive materials, preferably a metallic wire or metallic braid. Typically, the heaters are formed by applying a resistive heating layer over a substrate and typically over both the substrate and the electric leads. The electric leads may be adhered to the substrate by an adhesive; however, the leads could be disposed in channels in the surface of a substrate or mechanically tied to the substrate, or simply laid upon the substrate. There may be additional layers between the resistive heating layer and the substrate; however, it is desirable that the entire structure be at least 60% transparent or substantially transparent (at least 80% transparent) in one or more desired regions in the IR or radio wavelengths.

The substrate may be any material and is preferably a ceramic or polymeric material or composite. Preferably, the substrate is electrically insulated in contact with the leads or insulated in areas in contact with the leads. Alternatively, or in addition, the leads may be sheathed in an insulating material to prevent having an electrical contact with the substrate.

The resistive heater layer(s) can be formed from any suitable material but is preferably a CNT-based heater. CNT-based resistive heaters and methods of making them are described in prior patents based on work done at Battelle Memorial Institute; these patents include US 2016/0137854, U.S. Pat. No. 9,468,043, US 2011/0250451, US 2009/0142581, US 2016/0221680, and US 2014/0070054. All of these patents are incorporated herein as if reproduced in full below.

CNT-based resistive heater layers can be prepared, for example, as a dispersion of CNTs applied directly to a substrate where the solvents used in the dispersion process are evaporated off leaving a layer of CNTs that coagulate together into a continuous network. The CNT network may be prepared from dispersions and applied by coating methods known in the art, such as, but not limited to, spraying (air assisted airless, airless or air), roll-coating, transfer printing, gravure printing, ink jet printing, flexography, brush applied and spin-coating. A multilayered laminate resistive heater could be manufactured with conventional roll coat equipment. The electronic leads could be printed on a base substrate.

The thickness of a heater layer is preferably in the range from 0.005 µm to 100 µm, in some embodiments in the range of 0.05 µm to 100 µm, in some embodiments in the range of 0.3 µm to 20 µm, and in some preferred embodiments in the range of 15 to 100 nm.

The heater layers preferably have low sheet resistance, for example less than 100 Ω/square, or in the range of 0.5 to 100 Ω/square, more preferably in the range of 0.5 to 3 Ω/square. The resistance of CNT films depends on the thickness of the film and the bulk conductivity of the film, which is a function of the solid loading of CNTs in the film, the dispersion quality, and the quality of the CNTs. Low resistance film can be prepared in few coating passes and is sufficiently thin to maintain adhesion with the substrate. The bulk conductivity of films is preferably in the range of 1500 to 6000 S/cm or 2000 to 6000 S/cm, more preferably in the range of 3000 to 6000 S/cm. The bulk conductivity can be determined by measuring the sheet resistance (Ω/square) and the thickness of the CNT film. The bulk conductivity is the inverse of the bulk resistivity, which is determined as the (sheet resistance) · thickness). Sheet resistance may be determined by standard methods such as 4-point probe at room temperature.

A CNT layer typically includes a dispersing agent (such as hyaluronic acid or other glycosaminoglycan or polysaccharide). A CNT layer may include other optional additives. P-dopant additives could include, but are not limited to, perfluorosulfonic acids, thionyl chloride, organic pi-acids, nitrobenzene, organometallic Lewis acids, organic Lewis acids, or Bronsted acids. Materials that function as both dispersing agents and dopants such as Nafion. These materials contain p-doping moieties, i.e., electron accepting groups, within their structure, often as pendant groups on a backbone. Preferably, these additives will be present as less than 70% by weight of the CNT film, and in some embodiments as less than 50% by weight of the CNT film. Polymers and carbohydrates that function as both dispersing agents and dopants can be distinguished from other polymer materials, i.e., those functioning as only a dispersing agent or those functioning as a structural component. Because of the presence of electron accepting moieties, these materials can form a charge transfer complex with semiconducting CNTs, which p-dopes the semiconducting CNTs and raises the electrical conductivity. Thus, these dual dispersing agent / dopants can be tolerated at a higher mass percentage within the CNT layer than other types of polymer materials or surfactants.

Preferably, a protective coating overlies the resistive heating layer. The thickness of a coating composition over a heating layer is preferably 2 mm or less, more preferably 150 µm or less, preferably 50 µm or less, in some embodiments, a thickness of 250 nm to 50 µm. A coating composition can be applied over the resistive heating layer by known methods; for example, bar coating or spraying. Techniques, such as troweling, that disrupt a CNT network should be avoided. After application of a protective coating, the coated substrate can be cured (in some embodiments, curing is conducted at ambient temperature). In the curing operation, the film forming materials crosslink to leave a mechanically durable and chemically resistant film. The topcoat is preferably a polymer that is sufficiently thin to avoid significant absorption or is made from a transparent material.

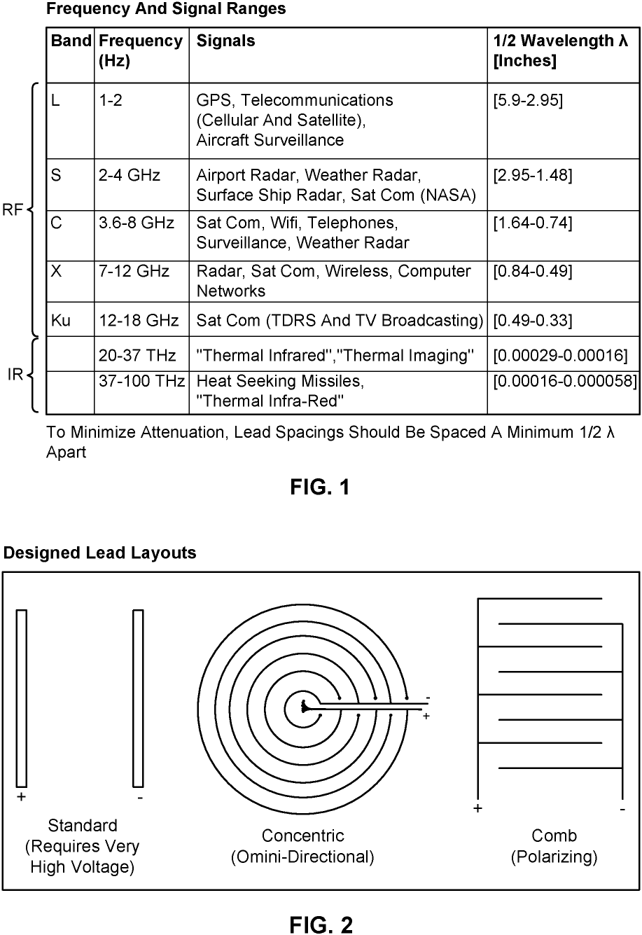

Preferably, the resistive heater layer (and preferably including substrate and leads) is RF transparent such that the heater exhibits a loss of 5 dB or less from one or any combination of 1 to 4 GHz, or 1 to 10 GHz, or 2 to 18 GHz, or from 4 to 16 GHz, or in the L Band, S Band, C Band, X Band, and/or Ku Band. Preferably, a flat sample exhibits an RF loss that is independent of rotation (i.e., RF transparency is independent of rotation). The frequency ranges are shown in FIG. 1.

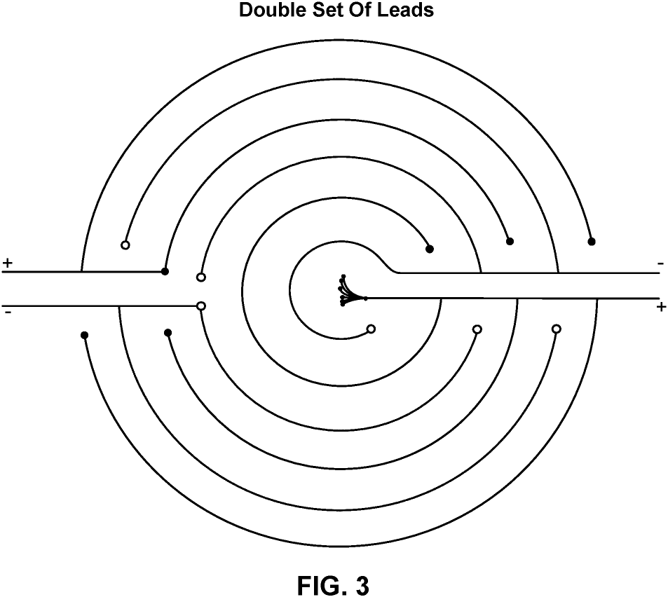

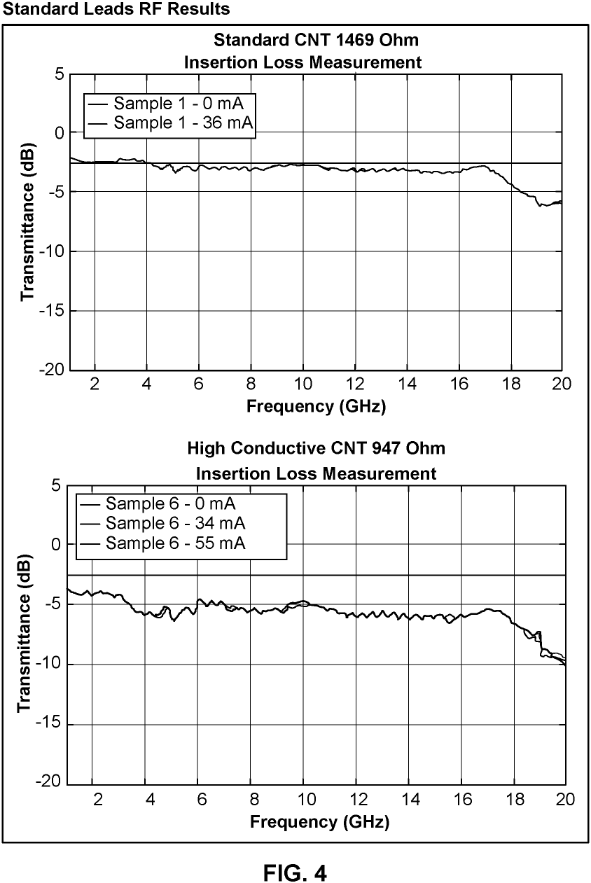

The electrical leads can have a standard configuration. In some preferred embodiments, the electrical leads have a concentric design (as shown in the drawings) with a plurality of alternating positive and negative leads; for example, at least 3 negative leads alternating with at least 3 positive leads. The leads should conform to the resistive heating layer (or vice versa) in the area of interest, and preferably also conform to the surface of the substrate. A preferred shape is a dome shape. In some embodiments, the leads are coplanar or substantially coplanar along their length or substantially along their length. To minimize attenuation, leads should be spaced apart a minimum of ½ the wavelength of the frequencies of interest. In some embodiments, the leads are separated by at least 2 cm, or at least 3 cm, or at least 5 cm, or at least 8 cm, and in some cases, a maximum separation of 15 cm or 10 cm. A comb design was found undesirable unless the polarizing effect is desired. A “comb-like” design has alternating positive and negative leads where the leads have lengths such that the ends of the positive leads do not extend to the beginning of the negative leads and the ends of the negative leads do not extend to the beginning of the positive leads (see FIG. 2). It may be noteworthy to describe that this spacing between the lead ends and the opposite lead trunk is intentionally the same or approximately the same as the spacing between alternating leads. This is to prevent areas of current concentration caused by reduced lead-to-lead resistance resulting from a shorter lead-to-lead path in a pseudo-uniform resistive film. It may also be noteworthy to describe that lead ends may be formed with circular or otherwise rounded edges. This is to prevent areas of current concentration caused by sharp lead features. Such rounding is depicted in FIG. 3. Preferably, the negative leads share a first common connecting lead and the positive leads share a second common connecting lead to appear like two interdigitated combs (see FIG. 2). Two of the inventive concentric designs are in FIG. 2 (one set of common leads) and FIG. 3 (two sets of common leads).

The test samples shown below were of CNT on a substrate with no protective coating. The test samples were placed between a matching pair of antennas that measured the transmission of wavelengths from 2 GHz to 18 GHz. The samples were placed in two orientations to test the lead configuration impact on polarization. The results of these tests are shown in the data set below.

In addition to the RF range the coatings were tested in the IR range from 2000 to 15,000 nm as shown in the data below. The heaters were shown to have good transmission over a subset of wavelengths in this range. The application of doping would improve the range of wavelengths over which the heaters are transparent.

### EXAMPLES

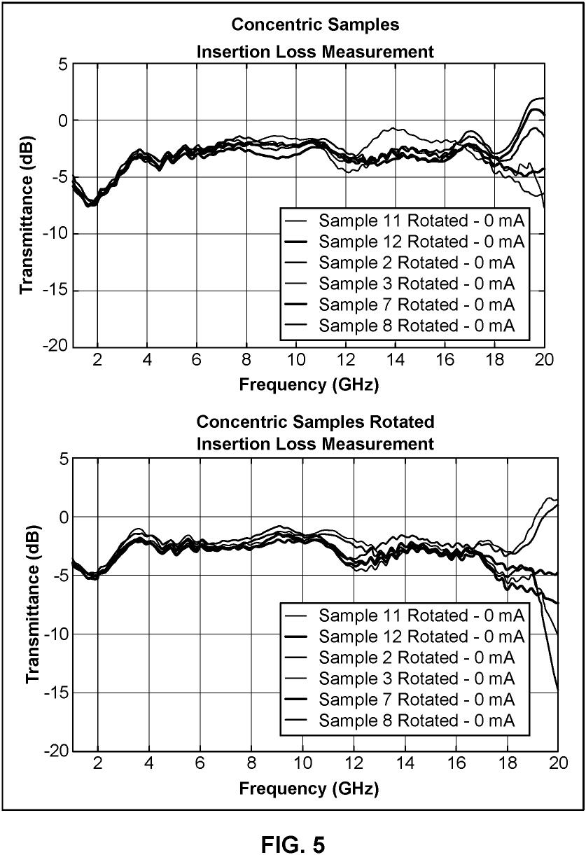

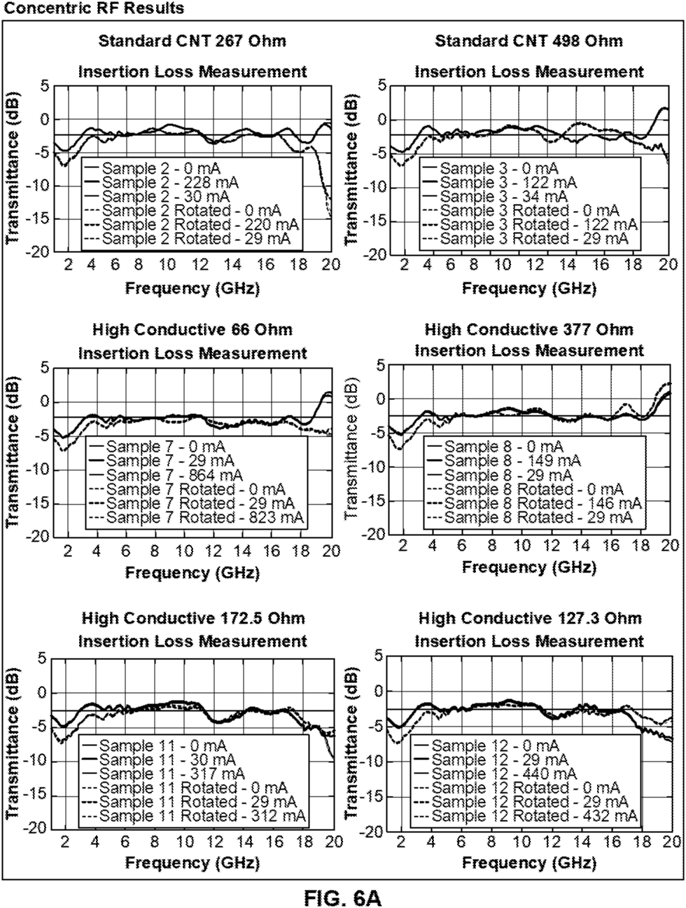

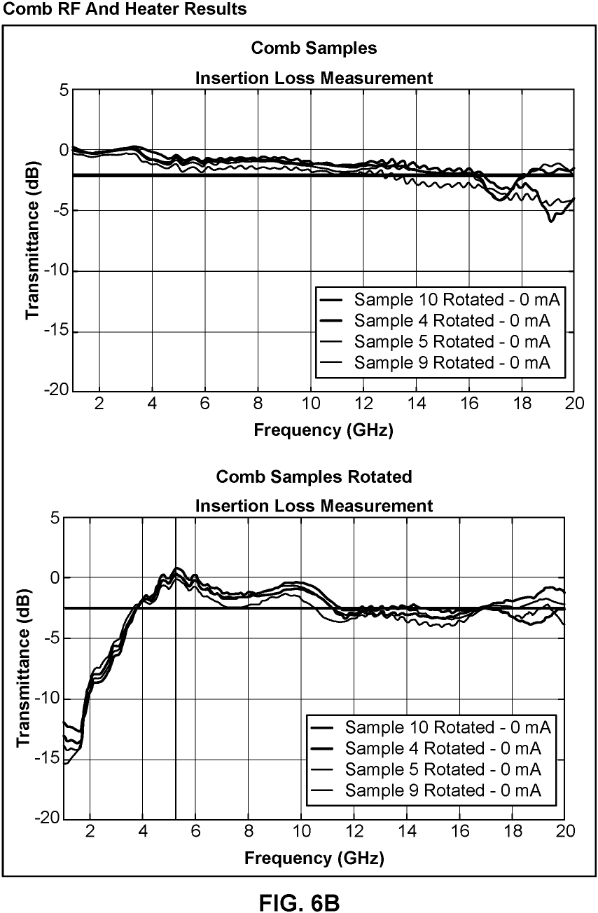

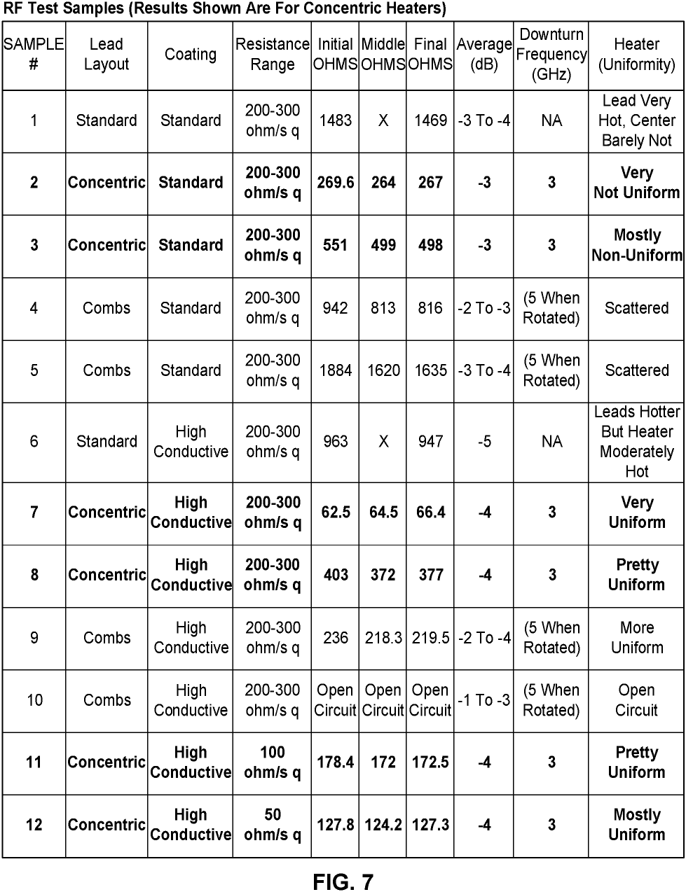

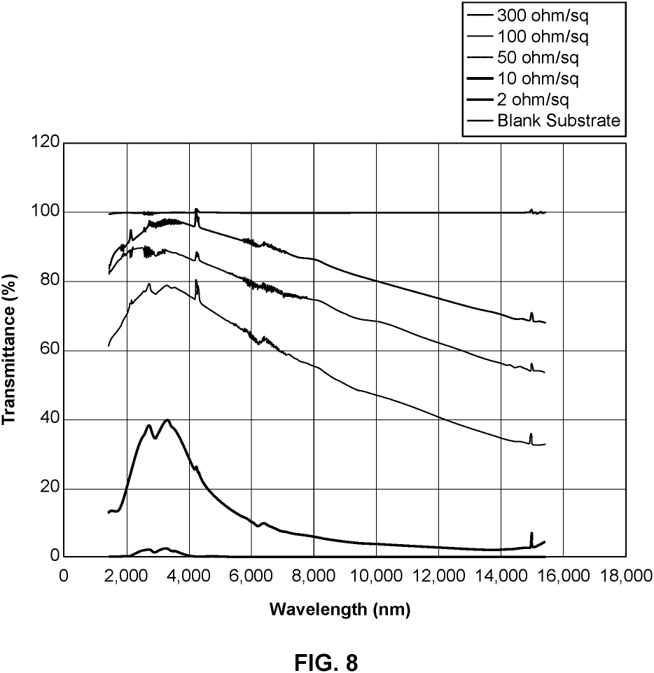

Results of testing the three configurations shown in FIG. 2 are shown in FIGS. 4-8 . FIG. 4 shows transmittance as a function of frequency at resistances of 1469 ohm/square and 947 ohm/square for the standard configuration that did not provide even heating over the surface. FIG. 5 shows the results for the concentric configuration. Both the standard and concentric configurations were not sensitive to the position of the radiation while the comb configuration was found to polarize for frequencies below 4 GHz (see FIG. 6B). FIG. 7 tabulates the various samples tested for which results are shown in the previous plots. Various test observations are recorded for the test sample set. FIG. 8 shows transmittance as a function of wavelength for leadless sample pucks at five coatings at varying resistance.

FIG. 4 shows the transmittance results of two test configurations of the “standard” leads (long-path). The two polarizations were nearly indistinguishable, indicating geometry is not position sensitive. The losses were below the allowable threshold (horizontal line through figure) for the majority of both tests, showing poor transparency.

FIG. 6A shows results of the concentric lead test. The test result traces are not greatly divergent, indicating low sensitivity to orientation. A significant portion of the measurements were at or above the allowable threshold, showing marginal transparency above the “knee” frequency below which the lead spacing is too narrow to support transmission. FIG. 6A also shows the conductivity of the film layer is not a significant driver of the transparency characteristic.

FIG. 6B shows a significant portion of the measurements were at or above the allowable threshold (horizontal line through figure). The polarizing effect of the parallel linear lead configuration (second part of figure) is apparent in the vast difference in transmittance measured below the “knee” frequency.

FIG. 8 shows the graphical results of the FTIR testing of six substrate pucks treated with various conductivities of film. Lead spacings compatible with RF transparency are large enough to have negligible effect on optical frequencies, therefore leads were omitted from the FTIR test specimens. At least one sample demonstrated at least 70% transmittance for a portion of the IR band.

What is claimed:

1. A resistive heater system, comprising: a substrate; a resistive heating element disposed on the substrate comprising a plurality of alternating, concentric positive and negative electric leads coated by a resistive heating layer.

2. The radome comprising the resistive heater system of claim 1.

3. The resistive heater system of claim 1 comprising a radio or infrared transmitter or receiver or transceiver at least partly housed within the resistive heater system.

4. The resistive heater system of claim 1 wherein the resistive heating element comprises a CNT resistive heating layer.

5. The resistive heater system of claim 4 wherein the CNT resistive heating layer has a thickness in the range of 15 to 200 nm and a resistance of 100 to 400 ohm/sq.

6. The resistive heater system of claim 1 wherein the resistive heating element is at least 70% transparent in the wavelength range of one or any combination of 1 to 4 GHz, or 1 to 10 GHz, or 2 to 18 GHz, or from 4 to 16 GHz, or in the L Band, S Band, C Band, X Band, and/or Ku Band.

7. The resistive heater system of claim 5 wherein the resistive heating element is at least 70% transparent in the wavelength range of one or any combination of 1 to 4 GHz, or 1 to 10 GHz, or 2 to 18 GHz, or from 4 to 16 GHz, or in the L Band, S Band, C Band, X Band, and/or Ku Band.

8. The resistive heater system of claim 7 wherein resistive heater system maintains at least 70% transparency while constant current is passed through the system to generate heat sufficient to melt a 3 mm thick ice layer from the surface of the system in an ambient atmosphere maintained at -20° C.

9. The resistive heater system of claim 6 wherein resistive heater system maintains at least 80% transparency in the wavelength range of 4 to 16 GHz while constant current is passed through the system to generate heat sufficient to melt a 3 mm thick ice layer from the surface of the system in an ambient atmosphere maintained at -20° C.

10. The resistive heater system of claim 1 comprising at least 3 concentric positive leads alternating with at least 3 concentric negative leads.

11. The resistive heater system of claim 10 wherein the at least 3 concentric positive leads share a common first lead and wherein the at least 3 concentric negative leads share a common second lead.

12. A resistive heater system comprising: a substrate; a resistive heating element disposed on the substrate comprising alternating positive and negative electric leads coated by a CNT resistive heating layer having a thickness in the range of 15 to 200 nm, and a resistance of 100 to 400 ohm/sq.

13. The resistive heater system of claim 12 wherein the CNT resistive heating layer has a thickness in the range of 15 to 100 nm.

14. The resistive heater system of claim 12 wherein the resistive heating element is at least 70% transparent in the wavelength range of one or any combination of 1 to 4 GHz, or 1 to 10 GHz, or 2 to 18 GHz, or from 4 to 16 GHz, or in the L Band, S Band, C Band, X Band, and/or Ku Band.

15. The resistive heater system of claim 14 wherein resistive heater system maintains at least 70% transparency while constant current is passed through the system to generate heat sufficient to melt a 3 mm thick ice layer from the surface of the system in an ambient atmosphere maintained at -20° C.

16. The resistive heater system of claim 14 wherein resistive heater system maintains at least 70% transparency while constant current is passed through the system to generate heat sufficient to melt a 3 mm thick ice layer from the surface of the system in an ambient atmosphere maintained at -20° C.

17. The resistive heater system of claim 14 wherein resistive heater system maintains at least 70% transparency while constant current is passed through the system to generate heat sufficient to melt a 3 mm thick ice layer from the surface of the system in an ambient atmosphere maintained at -20° C.

18. The resistive heater system of claim 12 comprising at least 3 positive leads that share a common first lead and at least 3 negative leads that share a common second lead.

19. A polarizable resistive heater system, comprising: a substrate; a resistive heating element disposed on the substrate comprising a comb-like structure of positive and negative electric leads coated by a resistive heating layer; wherein the comb-like structure comprises a series of at least 3 positive electric leads alternated (or interdigitated) with at least 3 negative electric leads.

20. The polarizable resistive heater system of claim 19 wherein the positive leads share a common first lead and the negative leads share a common second lead.
